(19) United States
(12) Patent Application Publication
(10) Pub. No.: US 2026/0338619 A1
(43) Pub. Date: Oct. 29, 2026

(54) Full-Depth Temperature Profile Inversion Method and System Based on Fixed-Depth Data

(71) Applicant: Institute of Acoustics, Chinese Academy of Sciences, Beijing (CN)

(72) Inventors: Jixing QIN, Beijing (CN); Qianqian LI, Qingdao (CN); Xian YAN, Qingdao (CN); Yiming GU, Beijing (CN); Haibin WANG, Beijing (CN); Mengyuan WANG, Beijing (CN); Shuanglin WU, Beijing (CN)

(21) Appl. No.: 19/106,963

(22) PCT Filed: Oct. 14, 2022
(86) PCT No.: PCT/CN2022/125403

§ 371 Date: Feb. 26, 2025

(30) Foreign Application Priority Data
Sep. 29, 2022 (CN) 202211200508.7

(51) Int. Cl. G01K 13/02; G06N 3/04; G06N 3/084

(52) U.S. Cl. CPC G01K 13/026; G06N 3/04; G06N 3/084

(57) ABSTRACT

A full-depth temperature profile inversion method and system based on fixed-depth data. The method includes: acquiring, in real time, ocean temperatures at two fixed depths; inputting acquired temperature values into a pre-established and trained neural network model, so as to obtain p orders of empirical orthogonal function (EOF) coefficients; and extracting an average temperature profile and the first p orders of EOF basis functions from historical hydrological data, and calculating a full-depth temperature profile by using the p orders of EOF coefficients. The method does not require the deployment of a deep vertical temperature chain, has a low system complexity, facilitates deployment and operations, and can be applied in a relatively large area; deep-sea temperatures are acquired by using autonomous underwater vehicles (AUVs), such that the good maneuverability is achieved; and the deployment can be performed according to task requirements, thereby realizing modeling of a three-dimensional temperature field in a large area.

### RELATED APPLICATIONS

This application claims priority to Chinese Patent Application No. 202211200508.7, filed on Sep. 29, 2022, and entitled “FULL-DEPTH TEMPERATURE PROFILE INVERSION METHOD AND SYSTEM BASED ON FIXED-DEPTH DATA”, which is incorporated herein by reference in its entirety.

### TECHNICAL FIELD

The present invention relates to the fields of underwater acoustics engineering, ocean engineering, and sonar technologies, and specifically to a full-depth temperature profile inversion method and system based on fixed-depth data.

### BACKGROUND

The most important acoustic parameter in seawater is the sound wave propagation velocity, and the vertical distribution of a seawater sound speed profile is one of the main factors affecting the characteristics of an underwater acoustic field, which determines the refraction and propagation paths of sound waves in the ocean. Seawater temperature is the factor that most affects the sound speed, and therefore it is critical to acquire a full-depth temperature profile nearly in real time.

Generally, temperature data usually needs to be sampled in situ via CTD, XBT, or mooring temperature chains. However, the method is time-consuming and labor-intensive, and does not allow for simultaneous acquisition of data over large areas. Therefore, scientists prefer inversion methods. Satellite remote sensing can acquire sea surface temperature data over large areas and even globally in real time, and has high spatial resolution. The method of regression statistical analysis can construct empirical regression models of sea surface temperature anomalies, sea surface height anomalies, and full-depth temperature profiles, and then a three-dimensional ocean temperature field can be obtained through inversion. However, the accuracy is low near a thermocline. Sound speed profiles can be estimated by using artificial neural network methods and using sea surface parameters. However, information obtained from data of remote sensing satellites only stays in the surface or near-surface layer of the ocean, and the inversion using surface layer information only yields an average steady state field of a temperature profile, which has a low inversion accuracy. See Reference Document [1] (“Estimation of Sound Speed Profiles Using Artificial Neural Networks”, published in Issue 3 of IEEE Geoscience & Remote Sensing Letters in 2006, starting on page 467). Ocean acoustic tomography is also a common inversion method that can be used to monitor mesoscale processes in the ocean by using an acoustic method. However, the high power consumption of a transmitter-receiver has been a limiting factor for active acoustic tomography. Researchers have used historical hydrological data in combination with temperatures directly measured over a limited depth range (20 m to 40 m) to reconstruct sound speed profiles over a full-depth range, but have not researched problems such as that a minimum depth range of measured data needs to be used to reconstruct full-depth sound speed profiles. See Reference Document [2] (“Reconstruction of full-depth sound speed profiles using limited depth sound speed data”, published in Issue 5 of Acoustic Technology in 2008, starting on page 106).

With the continuous development of science and technology, autonomous underwater vehicles (AUVs) are increasingly used in ocean characteristic observation, and the rapid development of AUVs has made it possible to directly measure hydrological parameters at any depth. An AUV may be equipped with a temperature sensor, and after buoyancy reaches basic equilibrium, temperature data at a specified depth may be acquired by regulating a yaw angle and a pitch angle.

### SUMMARY OF THE INVENTION

An objective of the present invention is to overcome the deficiency that a three-dimensional ocean temperature field obtained through inversion in the prior art has low accuracy near a thermocline.

To achieve the foregoing objective, the present invention provides a full-depth temperature profile inversion method based on fixed-depth data, where the method includes:
Step S1: acquiring, in real time, ocean temperatures at two fixed depths;
Step S2: inputting acquired temperature values into a pre-established and trained neural network model, so as to obtain p orders of empirical orthogonal function (EOF) coefficients; and
Step S3: extracting an average temperature profile and the first p orders of EOF basis functions from historical hydrological data, and calculating a full-depth temperature profile by using the p orders of EOF coefficients.

As an improvement to the foregoing method, the neural network model uses a BP neural network, and training of the neural network is completed through the temperatures at the fixed depths and historical hydrological data of the first p orders of EOF coefficients;
a training process of the BP neural network includes a phase of forward propagation and a phase of backpropagation;
first, in forward propagation, two pieces of fixed-depth temperature data are inputted, are fed through an input layer, and reach an output layer after layer-by-layer processing by a hidden layer to obtain a network calculation result; an error between the network calculation result and an actual output is calculated according to a loss function loss=|yₒᵤₜ−y|, where yₒᵤₜ is a network output, and y is the actual output; and if a loss error exceeds a set threshold, the phase of backpropagation is entered;
in backpropagation, the loss error is transferred backward into the input layer through the hidden layer, and the error is distributed on average to all units of the layers, and connection weight values of the units are corrected according to a gradient descent method; and
forward propagation and backpropagation are performed cyclically to continuously adjust the connection weight values, and training of the model is completed when the loss error falls within a threshold range.

As an improvement to the foregoing method, Step S1 is specifically: according to corresponding depths at two extrema of a p^{th} order of EOF basis function extracted from the historical hydrological data, deploying two AUVs at the two fixed depths in a specified sea area, where a temperature sensor is equipped on each of the AUVs, and after buoyancy reaches basic equilibrium, acquiring, in real time, temperature data at the two fixed depths by regulating a yaw angle and a pitch angle.

As an improvement to the foregoing method, Step S3 is specifically:
obtaining sampled values of temperature profiles in historical water level data at M time points, where each temperature profile has N values in depth after layered processing, and samples of M temperature profiles are represented in a matrix form:

$$T = [ \begin{matrix}{t}_{1} ( {z}_{1} ) & {t}_{2} ( {z}_{1} ) & L & {t}_{M} ( {z}_{1} ) \\ {t}_{1} ( {z}_{2} ) & {t}_{2} ( {z}_{2} ) & L & {t}_{M} ( {z}_{2} ) \\ M & M & O & M \\ {t}_{1} ( {z}_{N} ) & {t}_{2} ( {z}_{N} ) & L & {t}_{M} ( {z}_{N} )\end{matrix} ] ,$$

where t_{M}(z_{N}) represents a value of the temperature profile at an M^{th} time point and at an N^{th} depth, and average temperatures of the M temperature profiles in each layer are calculated to obtain the average temperature profile T̅:

T̅=[t̅(z₁)t̅(z₂)Lt̅(z_{N})]^{T},
where [ ]^{T} represents transposing a vector; and the average temperature profile T̅ is subtracted from the temperature matrix T to obtain temperature disturbance:

ΔT=T−T̅,
performing singular value decomposition on ΔT to obtain:

ΔT^{T}=UΣV^{T},
where V=[v₁,L v_{N}]∈R^{N×N} is a feature vector of a matrix ΔTΔT^{T}∈R^{N×N}, and is an EOF to be extracted; U=[u₁,L u_{M}]∈R^{M×M} is a feature vector of a matrix ΔT^{T}ΔT∈R^{M×M}, and Σ=diag([λ₁ L λ_{N}])∈R^{M×N} represents a feature value matrix; a feature value corresponding to each feature vector represents a weight of the feature vector; and a cumulative variance contribution rate of the first m orders of modal functions is represented as:

$${E}_{m} = \frac{{\sum }_{k = 1}^{m} {λ}_{k}^{2}}{trace ( {\sum }^{2} )} ,$$

where

$${\sum }^{2} = diag ( [ {λ}_{1}^{2} , L , {λ}_{N}^{2} ] ) ∈ {R}^{M \times N} ,$$

and λₖ represents a k^{th} feature value; and
reconstructing a temperature profile by using the first p orders of EOF basis functions with the contribution rate Eₘ greater than 95% to obtain a full-depth temperature profile matrix:

$${\hat{T}}_{N \times M} = [ \begin{matrix}{\overline{T}}_{1} \\ {\overline{T}}_{2} \\ M \\ {\overline{T}}_{N}\end{matrix} ] + [ \begin{matrix}{V}_{11} & {V}_{12} & L & {V}_{1 p} \\ {V}_{21} & {V}_{22} & L & {V}_{2 p} \\ M & M & L & M \\ {V}_{N 1} & {V}_{N 2} & L & {V}_{Np}\end{matrix} ] [ \begin{matrix}{α}_{1 M} \\ {α}_{2 M} \\ M \\ {α}_{pM}\end{matrix} ] ,$$

where [α_{1M} α_{2M} L α_{pM}]^{T} represents the first p orders of a coefficient matrix UΣ=[α₁ L α_{N}]∈R^{M×N}; and

$$[ \begin{matrix}{V}_{11} & {V}_{12} & L & {V}_{1 p} \\ {V}_{21} & {V}_{22} & L & {V}_{2 p} \\ M & M & L & M \\ {V}_{N 1} & {V}_{N 2} & L & {V}_{Np}\end{matrix} ]$$

represents the first p orders of a matrix V=[v₁, L, v_{N}]∈R^{N×N},
where a temperature value at an i^{th} depth in the temperature profile is:

\hat{t}(zᵢ)=t̅(zᵢ)+α₁v₁+α₂v₂+L+αₚvₚ,
where i∈N; and αₚ represents a p^{th} order of EOF coefficient, vₚ represents a p^{th} order of EOF basis function, and t̅(zᵢ) represents an average temperature at the i^{th} depth in the historical water level data.

As an improvement to the foregoing method, p is preferably 2.

The present invention further provides a full-depth temperature profile inversion system based on fixed-depth temperature data, where the system includes:
a temperature acquisition module, configured to acquire, in real time, ocean temperatures at two fixed depths;
an EOF coefficient calculation module, configured to input acquired temperature values into a pre-established and trained neural network model, so as to obtain p orders of EOF coefficients; and
a full-depth temperature inversion module, configured to extract an average temperature profile and the first p orders of EOF basis functions from historical hydrological data, and calculate a full-depth temperature profile by using the p orders of EOF coefficients.

As an improvement to the foregoing system, the system further includes:
a neural network training module, configured to complete training of the neural network through the temperatures at the fixed depths and historical hydrological data of the first p orders of EOF coefficients, where
the neural network uses a BP neural network, and a training process includes a phase of forward propagation and a phase of backpropagation;
first, in forward propagation, two pieces of fixed-depth temperature data are inputted, are fed through an input layer, and reach an output layer after layer-by-layer processing by a hidden layer to obtain a network calculation result; an error between the network calculation result and an actual output is calculated according to a loss function loss=|yₒᵤₜ−y|, where yₒᵤₜ is a network output, and y is the actual output; and if a loss error exceeds a set threshold, the phase of backpropagation is entered;
in backpropagation, the loss error is transferred backward into the input layer through the hidden layer, and the error is distributed on average to all units of the layers, and connection weight values of the units are corrected according to a gradient descent method; and
forward propagation and backpropagation are performed cyclically to continuously adjust the connection weight values, and training of the model is completed when the loss error falls within a threshold range.

The present invention further provides a computer device, including a memory, a processor, and a computer program that is stored in the memory and that can be run on the processor, where when executing the computer program, the processor implements any foregoing method.

The present invention further provides a computer-readable storage medium, where the computer-readable storage medium stores a computer program, and the computer program, when being executed by a processor, causes the processor to perform any foregoing method.

Compared with the prior art, the advantages of the present invention are as follows:

In the method in the present invention, it is only necessary to use data of a temperature sensor equipped on an AUV to acquire limited one or two pieces of fixed-depth temperature data, so that a full-depth temperature profile can be obtained in real time through inversion. Compared with conventional observation manners such as fixed-point observation, ship-based observation, and moored buoy array observation, the method can implement mobile observation, and has high autonomy, high load capacity, good mobility, and high degree of intelligence, to meet the economy and at the same time meet the requirements of the accuracy of measurement data.

### BRIEF DESCRIPTION OF THE DRAWINGS

FIG. 1 is a flowchart of training and inversion of a neural network model in a full-depth temperature profile inversion method based on fixed-depth data;

FIG. 2 is a schematic diagram of errors in performing inversion of a full-depth temperature profile by using water temperature data at different depths;

FIG. 3 is a diagram of a cumulative variance contribution rates of the first 15 orders of EOFs;

FIG. 4 is a diagram of a relationship between the first two orders of EOF coefficients and a 24 °C isotherm and a temperature gradient, where FIG. 4(a) represents normalized amplitudes of the first order of EOF coefficient and the 24 °C isotherm, and FIG. 4(b) represents normalized amplitudes of the second order of EOF coefficient and the temperature gradient;

FIG. 5 is a scatter plot and fitted line plots of the first two orders of EOF coefficients and a 24 °C isotherm and a temperature gradient, where FIG. 5(a) represents a scatter plot and a fitted line of the first order of EOF coefficient and the 24 °C isotherm, and FIG. 5(b) represents a scatter plot and a fitted line of the second order of EOF coefficient and the temperature gradient;

FIG. 6 is a schematic diagram of errors in performing inversion of a full-depth temperature profile by using water temperature information at depths z₂ and z₃;

FIG. 7 is a schematic diagram of a fixed coordinate system and a body-fixed coordinate system of an AUV;

FIG. 8 shows a topology structure of a BP neural network; and

FIG. 9 is a flowchart of a full-depth temperature profile inversion method based on fixed-depth data.

### DETAILED DESCRIPTION

In the present invention, temperatures at one or two fixed depths are extracted by using survey data of an AUV, and a model that uses fixed-depth temperature data to perform inversion of a full-depth temperature profile is established based on a backpropagation neural network, so that problems that a conventional observation platform cannot acquire temperature data quickly in real time and has high costs can be resolved.

The technical solutions of the present invention is described below in detail with reference to the accompanying drawings.

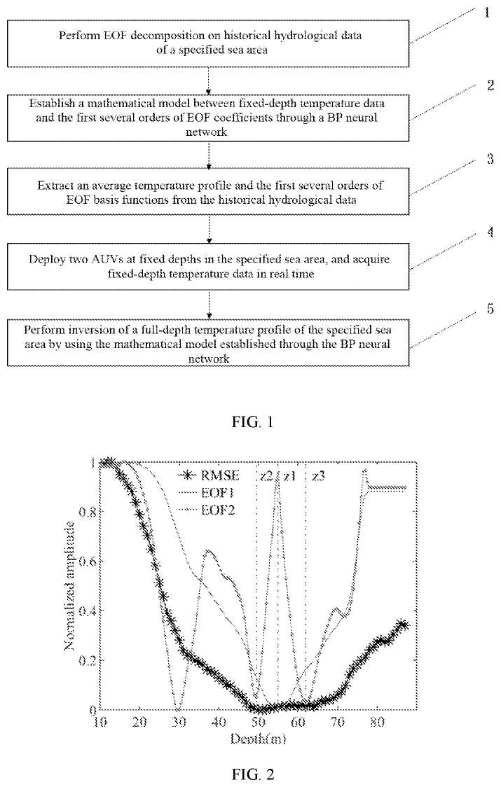

The present invention provides a full-depth temperature profile inversion method and system based on fixed-depth data, and is especially applicable to a case in which internal waves exist. Existing researches show that in an internal wave environment, any temperature profile can be reconstructed accurately by using the first two orders of EOF modes, and thermocline information can be maximally reflected by using information at depths of extrema of the first two orders of EOF basis functions. Based on this, a full-depth temperature profile inversion method by using limited fixed-depth temperature data is provided. First, a mathematical model between fixed-depth temperature data and the first two orders of EOF coefficients is established through a BP neural network, and then inversion of a temperature profile is implemented in combination with an average temperature profile and an EOF basis function extracted from historical hydrological data. A flowchart is shown in FIG. 1.

Step 1: Analyze an impact of selection of fixed-depth temperature data on inversion results of temperature profiles.

Values of water temperatures at any depths measured by an AUV or the like are replaced with measured temperatures at depths in historical hydrological data, to analyze an effect of performing inversion of a temperature profile using water temperatures at different depths. To determine an optimal selection standard of the fixed depth, measurement data of a temperature chain is used in the present invention to perform selection one by one at equal intervals (1 meter) in ascending order of depth. That is, the BP neural network is trained by using temperatures at fixed depths (from 10 m to 87 m at intervals of 1 m). In FIG. 2, a curve with * plots normalized average root mean square errors in inversion of a temperature profile using water temperatures at the depths, a solid curve plots a normalized first order of EOF basis function, and a curve with dots plots absolute values of a normalized second order of EOF basis function. Horizontal axis scales corresponding to three dashed lines respectively represent depths z₁, z₂, and z₃, where z₁ is a depth corresponding to an extremum of the first order of EOF basis function, and z₂ and z₃ are respectively depths corresponding to two extrema of the second order of EOF basis function. As can be seen from the figure, inversion accuracy approximately presents a “smiley face” as the depth changes. In other words, at depths less than z₂, an inversion error greatly drops along with the depth; at depths greater than z₃, the inversion error greatly rises along with the depth; and within a depth range of z₂ to z₃, the inversion error is small and basically remains unchanged. As can be seen from the figure, a temperature change at a discrete depth can reflect to some extent an overall form of a full-depth temperature profile. However, water temperatures at different depths contain different amounts of information, where water temperatures at the depth range of z₂ to z₃ contain the largest amount of information.

Step 2: Perform EOF decomposition on historical hydrological data, and analyze the physical significance of the first two orders of EOF basis functions and EOF coefficients.

If a temperature profile of seawater is directly estimated, a quantity of variables to be estimated is very large, and very high performance of an algorithm is required. Therefore, an EOF is used to represent the temperature profile of seawater. The EOF is a feature vector extracted from a particular quantity of sample data. Researches show that a temperature profile can be effectively reconstructed by using the first several orders of orthogonal functions. Temperature profiles are sampled at M time points, where each temperature profile has N values in depth after layered processing, and samples of M temperature profiles are represented in a matrix form:

$$T = [ \begin{matrix}{t}_{1} ( {z}_{1} ) & {t}_{2} ( {z}_{1} ) & L & {t}_{M} ( {z}_{1} ) \\ {t}_{1} ( {z}_{2} ) & {t}_{2} ( {z}_{2} ) & L & {t}_{M} ( {z}_{2} ) \\ M & M & O & M \\ {t}_{1} ( {z}_{N} ) & {t}_{2} ( {z}_{N} ) & L & {t}_{M} ( {z}_{N} )\end{matrix} ] , \qquad ( 1 )$$

where tᵢ(z)) represents a value of the temperature profile at an i^{th} sampling point and at a j^{th} depth, and average temperatures of the M temperature profiles in each layer are calculated to obtain the average temperature profile T̅:

T̅=[t̅(z₁) t̅(z₂) L t̅(z_{N})]^{T} (2),
where a symbol T represents transposing a vector; and the average temperature profile T̅ is subtracted from the temperature matrix T to obtain temperature disturbance:

ΔT=T−T̅ (3).

Singular value decomposition is performed on ΔT, and it may be obtained that:

ΔT^{T}=UΣV^{T} (4),
where V=[v₁,L v_{N}]∈R^{N×N} is a feature vector of a matrix A=ΔTΔT^{T} ∈R^{N×N}, and is an EOF to be extracted. U=[u₁,L u_{M}]∈R^{M×M} is a feature vector of a matrix B=ΔT^{T}ΔT∈R^{M×M} and Σ=diag([λ₁ L λ_{N}])∈R^{M×N} is a feature value matrix. X=UΣ∈R^{M×N} is a coefficient matrix.

$${\sum }^{2} = diag ( [ {λ}_{1}^{2} , L , {λ}_{N}^{2} ] ) ∈ {R}^{M \times N} ,$$

and Ω=[λ₁,L λ_{N}] is a feature value of a matrix A. A feature value corresponding to each feature vector represents a weight of the feature vector. When the feature value is smaller, the feature vector (EOF) corresponding to the feature value contains less information. A cumulative variance contribution rate of the first m orders of modal functions may be represented as:

$${E}_{m} = \frac{{\sum }_{k = 1}^{m} {λ}_{k}^{2}}{trace ( {\sum }^{2} )} , \qquad ( 5 )$$

where the first order of mode has the largest contribution rate, and when the order is higher, the contribution rate of the modal function is smaller.

A temperature profile is reconstructed by using the first p orders of EOF basis functions with the contribution rate Eₘ greater than 95%, and a reconstructed temperature profile matrix is represented as:

$${\hat{T}}_{N \times M} = [ \begin{matrix}{\overline{T}}_{1} \\ {\overline{T}}_{2} \\ M \\ {\overline{T}}_{N}\end{matrix} ] + [ \begin{matrix}{V}_{11} & {V}_{12} & L & {V}_{1 p} \\ {V}_{21} & {V}_{22} & L & {V}_{2 p} \\ M & M & L & M \\ {V}_{N 1} & {V}_{N 2} & L & {V}_{Np}\end{matrix} ] [ \begin{matrix}{α}_{1 M} \\ {α}_{2 M} \\ M \\ {α}_{pM}\end{matrix} ] ,$$

where [π_{1M} α_{2M} L α_{pM}]^{T} is the first p orders of a coefficient matrix UΣ=[α₁ L α_{N}]∈R^{M×N}; and

$$[ \begin{matrix}{V}_{11} & {V}_{12} & L & {V}_{1 p} \\ {V}_{21} & {V}_{22} & L & {V}_{2 p} \\ M & M & L & M \\ {V}_{N 1} & {V}_{N 2} & L & {V}_{Np}\end{matrix} ]$$

represents the first p orders of a matrix V=[v₁, L, v_{N}]∈R^{N×N}.

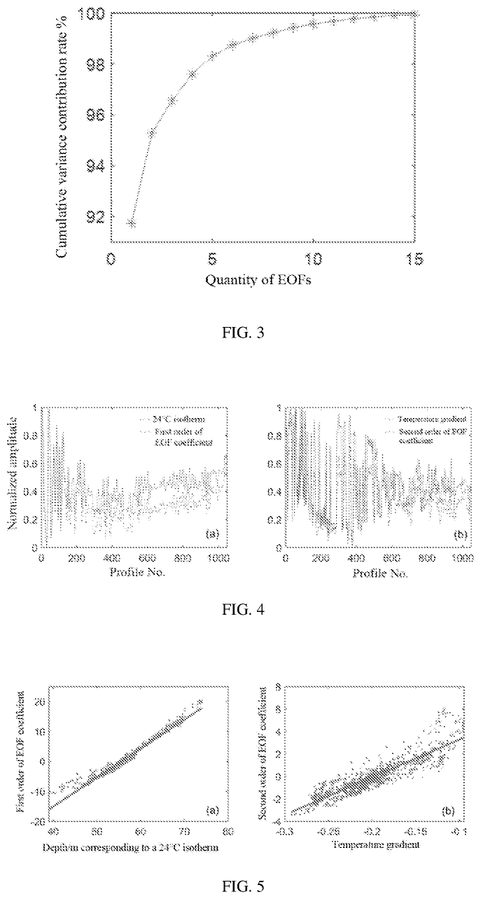

A cumulative variance contribution rate of the first 15 orders of EOF basis functions is calculated by performing EOF decomposition on the historical hydrological data. As shown in FIG. 3, it is found that a cumulative variance contribution rate of the first two orders of EOF modes of a South China Sea area may be up to 95% or above.

Therefore, the temperature profiles are reconstructed by using the first two orders of EOF basis functions, and an i^{th} temperature profile may be approximately represented as:

\hat{t}ᵢ(z)=tₘₑₐₙ±α₁v₁+α₂v₂ (6),
where αᵢ represents an i^{th} order of EOF coefficient, vᵢ represents an i^{th} order of EOF basis function, and tₘₑₐₙ represents an average ocean temperature at an i^{th} sampling moment in the historical water level data.

The physical significance of the first two orders of EOF basis functions and EOF coefficients is analyzed by combining the conclusion obtained from Step 1. Existing researches give a physical explanation for an EOF coefficient, the first order of EOF coefficient represents a vertical displacement of a thermocline, and when α₁ is larger, the thermocline is shallower. The second order of EOF coefficient represents a change in a temperature gradient, and when α₂ is larger, changes in the thermocline are more rapid, which is verified below. As can be seen from FIG. 2, a depth corresponding to an extremum of the first order of the EOF basis function is z₁=55 m. At this depth, an average temperature is T̅(z₁)=24 °C. FIG. 4(a) plots a normalized 24 °C isotherm and a normalized first order of EOF coefficient of a temperature profile in a training set. As can be seen from the figure, the isotherm is highly correlated with a change trend of the first order of projection coefficient, and a correlation coefficient is 0.98. FIG. 5(a) shows a scatter plot and a fitted line \hat{α}₁=f(z_{24 °C}) of a depth corresponding to the 24 °C isotherm and the first order of EOF coefficient, where z_{24 °C} is the depth corresponding to the 24 °C isotherm. The first order of EOF coefficient has a change trend close to that of a temperature of a seawater layer. Therefore, it can be further explained that the first order of EOF coefficient may approximately reflect a change trend of the seawater layer. As can be seen from FIG. 2, depths corresponding to two extrema of the second order of EOF basis function are respectively z₂=49 m and z₃=62 m, and a temperature gradient of the temperature profile in the training set in the depth range is calculated. FIG. 4(b) shows a normalized temperature gradient and a normalized second order of EOF coefficient. As can be seen from the figure, the temperature gradient is highly correlated with a change trend of the second order of projection coefficient, and a correlation coefficient reaches 0.90. FIG. 5(b) shows a scatter plot and a fitted line of the temperature gradient and the second order of EOF coefficient.

$${\hat{α}}_{2} = {f}_{1} ( \frac{T ( {z}_{3} ) - T ( {z}_{2} )}{{z}_{3} - {z}_{2}} ) . \qquad ( 7 )$$

The foregoing conclusion is consistent with existing researches. z₂ and z₃ respectively represent upper and lower boundaries of a thermocline. Therefore, water temperature data in the depth range z₂ to z₃ can maximally reflect thermocline information, so that accuracy is higher during inversion of the temperature profile. This also explains the conclusion obtained from Step 1. The foregoing analysis provides a reference for selection of a measurement depth of the fixed-depth temperature data.

Step 3: Perform inversion of a full-depth temperature profile by replacing fixed-depth temperature data acquired by an AUV with water temperature information at the depths z₂ and z₃.

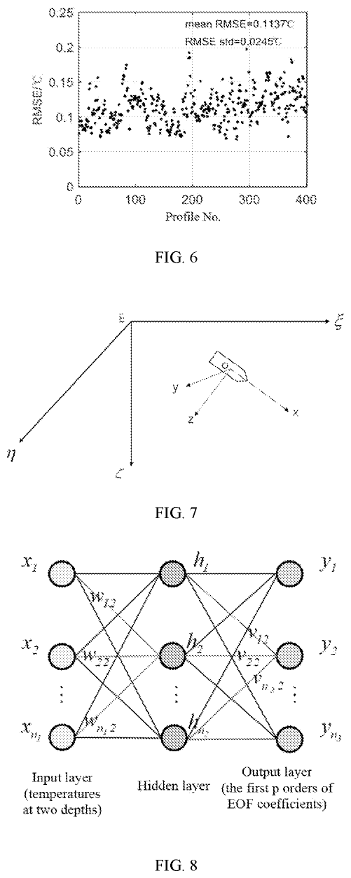

It is obvious that as information in an input layer increases, inversion accuracy of a temperature profile in the training set increases accordingly. Results in FIG. 2 show that the inversion accuracy depends on the measurement depth of the fixed-depth temperature data, and the temperature profile mainly depends on characteristics of the thermocline. Step 2 proves that z₂ and z₃ respectively represent depths of the upper and lower boundaries of the thermocline. Water temperatures at the two depths can basically determine the basic structure of the temperature profile. The inversion of the full-depth temperature profile is performed by replacing fixed-depth temperature data acquired by the AUV with the water temperature information at the two depths. Inversion results are shown in FIG. 6. Root mean square errors in the inversion of the temperature profile are basically below 0.2 °C, and an average value of the root mean square errors is 0.1137 °C.

Step 4: Measure fixed-depth temperature data at the upper and lower boundaries of the thermocline in communication with the analysis of the historical hydrological data and by using two AUVs.

For an AUV, fixed-depth navigation is a common navigation state. The two AUVs need to be equipped with temperature sensors to operate cooperatively, and perform fixed-depth navigation in a specified sea area to obtain the temperature data. After buoyancy reaches basic equilibrium, the fixed-depth navigation is implemented by regulating a yaw angle and a pitch angle of an AUV when the AUV has a particular surge speed. In a multi-AUV system, a fixed coordinate system needs to established to describe a change in a position of each AUV. Generally, the earth is used as a reference system to select a fixed coordinate system E−ξηζ. Any point on the ground or sea surface may be used as the origin E of the coordinate system. The axis Eξ is kept horizontal, and the main heading of the AUV is often used as a positive direction of Eξ. Axes Eη and Eξ are perpendicular to each other and are in a horizontal plane, and any directions may be selected for the axes. The axis Eζ is perpendicular to a coordinate plane of Eξη, and a positive direction of the axis points to the geocentre. To facilitate description of a mutual distance relationship between two moving AUVs, a body-fixed coordinate system further needs to be established, and the body-fixed coordinate system displaces as the AUV moves. In the body-fixed coordinate system, an axis Ox is located on a straight line formed by position points of two measuring AUVs. An axis Oy is perpendicular to an axis Oz, and the axis Oz is located in a longitudinal middle plane, points to a keel direction, and is perpendicular to a waterline plane, as shown in FIG. 7. To clearly observe an actual position and a navigation pattern of an underwater AUV, the body-fixed coordinate system needs to be transformed into a fixed coordinate system, and related experimental data extracted from the fixed coordinate system reflects a movement process of the underwater AUV more accurately and intuitively. Assuming that a coordinate value of the origin of the body-fixed coordinate system in the fixed coordinate system is (Oₓ,O_{y},O_{z}), a rotation angle of a coordinate axis is φ, coordinates of the AUV in the body-fixed coordinate system are (X₁,Y₁,Z₁), and coordinates of the AUV in the fixed coordinate system are (X₂,Y₂,Z₂), any point in the body-fixed coordinate system may be represented in the fixed coordinate system as:

$$\{ \begin{matrix}{X}_{2} = {X}_{1} cos φ + {Y}_{1} sin φ + {O}_{x} \\ {Y}_{2} = - {X}_{1} sin φ + {Y}_{1} cos φ + {O}_{y} \\ {Z}_{2} = {Z}_{1} + {O}_{z}\end{matrix} . \qquad ( 8 )$$

Step 5: Perform inversion of a full-depth temperature profile in real time through two pieces of fixed-depth temperature data measured by the AUVs.

A network model between the temperatures at the depths z₂ and z₃ and the first two orders of EOF coefficients is established by using the historical hydrological data through the BP neural network. As shown in FIG. 8, after being acquired through measurement by the AUVs, the water temperatures at the two depths are inputted into a trained network model, and inversion is performed in real time in combination with a historical average temperature profile and the first two orders of EOF basis functions to obtain the full-depth temperature profile.

A training process of the BP neural network includes a phase of forward propagation and a phase of backpropagation. First, in forward propagation, data (two pieces of fixed-depth temperature data) is inputted, is fed through an input layer, and reaches an output layer after layer-by-layer processing by a hidden layer to obtain a network calculation result. An error between the network calculation result and an actual output may be calculated according to a loss function loss=|yₒᵤₜ−y|, where yₒᵤₜ is a network output, and y is the actual output. If a loss error exceeds a set threshold, the phase of backpropagation is entered. In backpropagation, the loss error is transferred backward into the input layer through the hidden layer, and the error is distributed on average to all units of the layers, and connection weight values of the units are corrected according to a gradient descent method. Forward propagation and backpropagation are performed cyclically, so that the connection weight values can be continuously adjusted, and it indicates that training of the model is completed when the loss error falls within a threshold range.

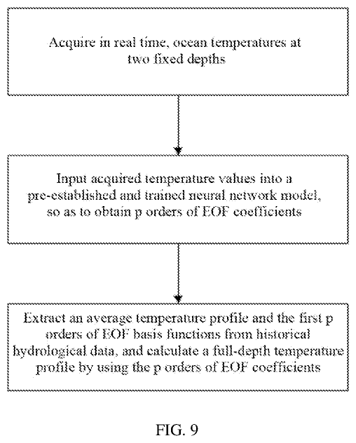

According to the foregoing testing process, the present invention provides a full-depth temperature profile inversion method based on fixed-depth data (as shown in FIG. 9). The method includes:
Step S1: Acquire in real time, ocean temperatures at two fixed depths;
according to corresponding depths at two extrema of a p^{th} order of EOF basis function extracted from the historical hydrological data, deploy two AUVs at the two fixed depths in a specified sea area, where a temperature sensor is equipped on each of the AUVs, and after buoyancy reaches basic equilibrium, acquire, in real time, temperature data at the two fixed depths by regulating a yaw angle and a pitch angle.
Step S2: Input acquired temperature values into a pre-established and trained neural network model, so as to obtain p orders of EOF coefficients.
Step S3: Extract an average temperature profile and the first p orders of EOF basis functions from historical hydrological data, and calculate a full-depth temperature profile by using the p orders of EOF coefficients:
obtaining sampled values of temperature profiles in historical water level data at M time points, where each temperature profile has N values in depth after layered processing, and samples of M temperature profiles are represented in a matrix form:

$$T = [ \begin{matrix}{t}_{1} ( {z}_{1} ) & {t}_{2} ( {z}_{1} ) & L & {t}_{M} ( {z}_{1} ) \\ {t}_{1} ( {z}_{2} ) & {t}_{2} ( {z}_{2} ) & L & {t}_{M} ( {z}_{2} ) \\ M & M & O & M \\ {t}_{1} ( {z}_{N} ) & {t}_{2} ( {z}_{N} ) & L & {t}_{M} ( {z}_{N} )\end{matrix} ] ,$$

where t_{M}(z_{N}) represents a value of the temperature profile at an M^{th} time point and at an N^{th} depth, and average temperatures of the M temperature profiles in each layer are calculated to obtain the average temperature profile T̅:

T̅=[t̅(z₁) t̅(z₂) L t̅(z_{N})]^{T},
where [ ]^{T} represents transposing a vector; and the average temperature profile T̅ is subtracted from the temperature matrix T to obtain temperature disturbance:

ΔT=T−T̅,
performing singular value decomposition on ΔT to obtain:

ΔT^{T}=UΣV^{T},
where V=[v₁,L v_{N}]∈R^{N×N} is a feature vector of a matrix ΔTΔT^{T}∈R^{N×N}, and is an EOF to be extracted; U=[u₁, L u_{M}]∈R^{M×M} is a feature vector of a matrix ΔT^{T}ΔT∈R^{M×M}, and Σ=diag([λ₁ L λ_{N}])∈R^{M×N} represents a feature value matrix; a feature value corresponding to each feature vector represents a weight of the feature vector; and a cumulative variance contribution rate of the first m orders of modal functions is represented as:

$${E}_{m} = \frac{{\sum }_{k - 1}^{m} {λ}_{k}^{2}}{trace ( {\sum }^{2} )} ,$$

where

$${\sum }^{2} = diag ( [ {λ}_{1}^{2} , L , {λ}_{N}^{2} ] ) ∈ {R}^{M \times N} ,$$

and λₖ represents a k^{th} feature value; and
reconstructing a temperature profile by using the first p orders of EOF basis functions with the contribution rate Eₘ greater than a set value to obtain a full-depth temperature profile matrix:

$${\hat{T}}_{N \times M} = [ \begin{matrix}{\overline{T}}_{1} \\ {\overline{T}}_{2} \\ M \\ {\overline{T}}_{N}\end{matrix} ] + [ \begin{matrix}{V}_{11} & {V}_{12} & L & {V}_{1 p} \\ {V}_{21} & {V}_{22} & L & {V}_{2 p} \\ M & M & L & M \\ {V}_{N 1} & {V}_{N 2} & L & {V}_{Np}\end{matrix} ] [ \begin{matrix}{α}_{1 M} \\ {α}_{2 M} \\ M \\ {α}_{pM}\end{matrix} ] ,$$

where [α_{1M} α_{2M} L α_{pM}]^{T} represents the first p orders of a coefficient matrix UΣ=[α₁ L α_{N}]∈R^{M×N}; and

$$[ \begin{matrix}{V}_{11} & {V}_{12} & L & {V}_{1 p} \\ {V}_{21} & {V}_{22} & L & {V}_{2 p} \\ M & M & L & M \\ {V}_{N 1} & {V}_{N 2} & L & {V}_{Np}\end{matrix} ]$$

represents the first p orders of a matrix V=[v₁, L, v_{N}]∈R^{N×N},
where a temperature value at an i^{th} depth in the temperature profile is:

\hat{t}(zᵢ)=t̅(zᵢ)+α₁v₁+α₂v₂+L+αₚvₚ,
where i∈N; and αₚ represents a p^{th} order of EOF coefficient, vₚ represents a p^{th} order of EOF basis function, and t̅(zᵢ) represents an average temperature at the i^{th} depth in the historical water level data. p is preferably 2.

The neural network model uses a BP neural network, and training of the neural network is completed through the temperatures at the fixed depths and historical hydrological data of the first p orders of EOF coefficients;

The present invention further provides a full-depth temperature profile inversion system based on fixed-depth temperature data, where the system includes:
a temperature acquisition module, configured to acquire, in real time, ocean temperatures at two fixed depths;
an EOF coefficient calculation module, configured to input acquired temperature values into a pre-established and trained neural network model, so as to obtain p orders of EOF coefficients; and
a full-depth temperature inversion module, configured to extract an average temperature profile and the first p orders of EOF basis functions from historical hydrological data, and calculate a full-depth temperature profile by using the p orders of EOF coefficients.

The system further includes:
a neural network training module, configured to complete training of the neural network through the temperatures at the fixed depths and historical hydrological data of the first p orders of EOF coefficients, where

The present invention may further provide a computer device, including at least one processor, a memory, at least one network interface, and a user interface. The various components in the device are coupled together by a bus system. The bus system is configured to implement connection and communication between the components. In addition to a data bus, the bus system further includes a power bus, a control bus, and a status signal bus.

The user interface may include a display, a keyboard or a click device (for example, a mouse, a trackball, a touch panel or a touch screen), and the like.

It may be understood that the memory in the disclosed embodiments of this application may be a volatile memory or a nonvolatile memory or may include both a volatile memory and a nonvolatile memory. The nonvolatile memory may be a ROM, a programmable ROM (PROM), an erasable programmable PROM (EPROM), an electrically EPROM (EEPROM) or a flash memory. The volatile memory may be a RAM used as an external cache. By way of example rather than limitation, many forms of RAMs such as a static RAM (SRAM), a dynamic RAM (DRAM), a synchronous DRAM (SDRAM), a double-data-rate (DDR) SDRAM, an enhanced SDRAM (ESDRAM), a synchronous-link DRAM (synchlink DRAM or SLDRAM), and a Direct Rambus RAM (DRRAM) may be used. The memory described in the present application intends to include, but not limited to, these and any other appropriate types of memories.

In some implementations, the memory stores the following elements, executable modules or data structures, or a subset thereof, or an extend set thereof: an operating system and an application.

The operating system includes various system programs such as a framework layer, a core library layer, and a driver layer, and is configured to implement various basis services and process a hardware-based task. The application includes various applications such as a media player or a browser, and is configured to implement various application services. A program for implementing the method provided in the embodiments of the present disclosure may be included in the application.

In the foregoing embodiments, the processor may be further configured to, by calling a program or instructions stored in the memory, specifically, a program or instructions stored in an application:
perform the steps in the foregoing method.

The foregoing method may be applied to the processor or implemented by using the processor. The processor may be disposed as an integrated circuit chip having a signal processing capability. During implementation, the steps in the foregoing method may be accomplished by hardware integrated logic circuits or instructions in a software form in the processor. The processor may be a general-purpose processor, a digital signal processor (DSP), an application-specific integrated circuit (ASIC), a field-programmable gate array (FPGA) or another programmable logic device, discrete gate or transistor logic device, a discrete hardware component. The methods, steps, and logic block diagrams disclosed above can be implemented or executed. The general-purpose processor may be a microprocessor, or the processor may be any conventional processor or the like. The steps with reference to the method disclosed above may be directly performed and accomplished by a hardware decoding processor or performed and accomplished by a combination of hardware and software modules in a decoding processor. The software modules may be located in a mature storage medium such as a RAM, a flash memory, a ROM, a PROM or an electrically erasable programmable memory or a register in the art. The storage medium is located in the storage. The processor reads information in the storage and accomplishes the steps in the foregoing method in combination with hardware of the processor.

1. A full-depth temperature profile inversion method based on fixed-depth data, wherein the method comprises:
Step S1: acquiring, in real time, ocean temperatures at two fixed depths;
Step S2: inputting acquired temperature values into a pre-established and trained neural network model, so as to obtain p orders of empirical orthogonal function (EOF) coefficients; and
Step S3: extracting an average temperature profile and the first p orders of EOF basis functions from historical hydrological data, and calculating a full-depth temperature profile by using the p orders of EOF coefficients.

2. The full-depth temperature profile inversion method based on fixed-depth temperature data according to claim 1, wherein the neural network model uses a BP neural network, and training of the neural network is completed through the temperatures at the fixed depths and historical hydrological data of the first p orders of EOF coefficients;
a training process of the BP neural network comprises a phase of forward propagation and a phase of backpropagation;
first, in forward propagation, two pieces of fixed-depth temperature data are inputted, are fed through an input layer, and reach an output layer after layer-by-layer processing by a hidden layer to obtain a network calculation result; an error between the network calculation result and an actual output is calculated according to a loss function loss=|yₒᵤₜ−y|, wherein yₒᵤₜ is a network output, and y is the actual output; and if a loss error exceeds a set threshold, the phase of backpropagation is entered;
in backpropagation, the loss error is transferred backward into the input layer through the hidden layer, and the error is distributed on average to all units of the layers, and connection weight values of the units are corrected according to a gradient descent method; and
forward propagation and backpropagation are performed cyclically to continuously adjust the connection weight values, and training of the model is completed when the loss error falls within a threshold range.

3. The full-depth temperature profile inversion method based on fixed-depth temperature data according to claim 1, wherein Step S1 is specifically: according to corresponding depths at two extrema of a p^{th} order of EOF basis function extracted from the historical hydrological data, deploying two autonomous underwater vehicles (AUVs) at the two fixed depths in a specified sea area, wherein a temperature sensor is equipped on each of the AUVs, and after buoyancy reaches basic equilibrium, acquiring, in real time, temperature data at the two fixed depths by regulating a yaw angle and a pitch angle.

4. The full-depth temperature profile inversion method based on fixed-depth temperature data according to claim 1, wherein Step S3 is specifically:
obtaining sampled values of temperature profiles in historical water level data at M time points, wherein each temperature profile has N values in depth after layered processing, and samples of M temperature profiles are represented in a matrix form:
$$T = [ \begin{matrix}{t}_{1} ( {z}_{1} ) & {t}_{2} ( {z}_{1} ) & L & {t}_{M} ( {z}_{1} ) \\ {t}_{1} ( {z}_{2} ) & {t}_{2} ( {z}_{2} ) & L & {t}_{M} ( {z}_{2} ) \\ M & M & O & M \\ {t}_{1} ( {z}_{N} ) & {t}_{2} ( {z}_{N} ) & L & {t}_{M} ( {z}_{N} )\end{matrix} ] ,$$
wherein t_{M}(z_{N}) represents a value of the temperature profile at an M^{th} time point and at an N^{th} depth, and average temperatures of the M temperature profiles in each layer are calculated to obtain the average temperature profile T̅:
T̅=[t̅(z₁) t̅(z₂) L t̅(z_{N})]^{T},
wherein represents transposing a vector; and the average temperature profile T is subtracted from the temperature matrix T to obtain temperature disturbance:
ΔT=T−\sqrt{T}
performing singular value decomposition on ΔT to obtain:
ΔT^{T}=UΣV^{T},
wherein V=[v₁,L v_{N}]∈R^{N×N} is a feature vector of a matrix ΔTΔT^{T}∈R^{N×N}, and is an EOF to be extracted; U=[u₁,L u_{M}]∈R^{M×M} is a feature vector of a matrix ΔT^{T}ΔT∈R^{M×M}, and Σ=diag([λ₁ L λ_{N}])∈R^{M×N} represents a feature value matrix; a feature value corresponding to each feature vector represents a weight of the feature vector; and a cumulative variance contribution rate of the first m orders of modal functions is represented as:
$${E}_{m} = \frac{{\sum }_{k - 1}^{m} {λ}_{k}^{2}}{trace ( {\sum }^{2} )} ,$$
wherein
$${\sum }^{2} = diag ( [ {λ}_{1}^{2} , L , {λ}_{N}^{2} ] ) ∈ {R}^{M \times N} ,$$
and λₖ represents a k^{th} feature value; and
reconstructing a temperature profile by using the first p orders of EOF basis functions with the contribution rate Eₘ greater than a set value to obtain a full-depth temperature profile matrix:
$${\hat{T}}_{N \times M} = [ \begin{matrix}{\overline{T}}_{1} \\ {\overline{T}}_{2} \\ M \\ {\overline{T}}_{N}\end{matrix} ] + [ \begin{matrix}{V}_{11} & {V}_{12} & L & {V}_{1 p} \\ {V}_{21} & {V}_{22} & L & {V}_{2 p} \\ M & M & L & M \\ {V}_{N 1} & {V}_{N 2} & L & {V}_{Np}\end{matrix} ] [ \begin{matrix}{α}_{1 M} \\ {α}_{2 M} \\ M \\ {α}_{pM}\end{matrix} ] ,$$
wherein [α_{1M} α_{2M} L α_{pM}]^{T} represents the first p orders of a coefficient matrix UΣ=[α₁ L α_{N}]∈R^{M×N}; and
$$[ \begin{matrix}{V}_{11} & {V}_{12} & L & {V}_{1 p} \\ {V}_{21} & {V}_{22} & L & {V}_{2 p} \\ M & M & L & M \\ {V}_{N 1} & {V}_{N 2} & L & {V}_{Np}\end{matrix} ]$$
represents the first p orders of a matrix V=[v₁,L, v_{N}]∈R^{N×N},
wherein a temperature value at an i^{th} depth in the temperature profile is:
\hat{t}(zᵢ)=t̅(zᵢ)+α₁v₁+α₂v₂+L+αₚvₚ,
wherein i∈N; and αₚ represents a p^{th} order of EOF coefficient, vₚ represents a p^{th} order of EOF basis function, and t̅(zᵢ) represents an average temperature at the i^{th} depth in the historical water level data.

5. The full-depth temperature profile inversion method based on fixed-depth temperature data according to claim 4, wherein p is preferably 2.

6. A full-depth temperature profile inversion system based on fixed-depth temperature data, wherein the system comprises:
a temperature acquisition module, configured to acquire, in real time, ocean temperatures at two fixed depths;
an empirical orthogonal function (EOF) coefficient calculation module, configured to input acquired temperature values into a pre-established and trained neural network model, so as to obtain p orders of EOF coefficients; and
a full-depth temperature inversion module, configured to extract an average temperature profile and the first p orders of EOF basis functions from historical hydrological data, and calculate a full-depth temperature profile by using the p orders of EOF coefficients.

7. The full-depth temperature profile inversion system based on fixed-depth temperature data according to claim 6, wherein the system further comprises:
a neural network training module, configured to complete training of the neural network through the temperatures at the fixed depths and historical hydrological data of the first p orders of EOF coefficients, wherein
the neural network uses a BP neural network, and a training process comprises a phase of forward propagation and a phase of backpropagation;
first, in forward propagation, two pieces of fixed-depth temperature data are inputted, are fed through an input layer, and reach an output layer after layer-by-layer processing by a hidden layer to obtain a network calculation result; an error between the network calculation result and an actual output is calculated according to a loss function loss=|yₒᵤₜ−y|, wherein yₒᵤₜ is a network output, and y is the actual output; and if a loss error exceeds a set threshold, the phase of backpropagation is entered;
in backpropagation, the loss error is transferred backward into the input layer through the hidden layer, and the error is distributed on average to all units of the layers, and connection weight values of the units are corrected according to a gradient descent method; and
forward propagation and backpropagation are performed cyclically to continuously adjust the connection weight values, and training of the model is completed when the loss error falls within a threshold range.

8. A computer device, comprising a memory, a processor, and a computer program that is stored in the memory and that can be run on the processor, wherein when executing the computer program, the processor implements the method according to any one of claims 1 to 5.

9. (canceled)
